(19) United States
(12) Patent Application Publication
(10) Pub. No.: US 2020/0254671 A1
(43) Pub. Date: Aug. 13, 2020

(54) STATE DETERMINATION DEVICE AND STATE DETERMINATION METHOD

(71) Applicant: FANUC CORPORATION, Yamanashi (JP)

(72) Inventor: Atsushi HORIUCHI, Yamanashi (JP)

(21) Appl. No.: 16/777,888

(22) Filed: Jan. 31, 2020

(30) Foreign Application Priority Data
Feb. 7, 2019 (JP) 2019-020409

(51) Int. Cl. B29C 45/76; G06N 20/00; G06N 3/04; G06N 3/08; B29C 37/00

(52) U.S. Cl. CPC B29C 45/768; G06N 20/00; B29C 37/0096; G06N 3/08; G06N 3/0454

(57) ABSTRACT

A state determination device acquires data on an industrial machine, creates a plurality of pieces of partial time-series data obtained by sliding time-series data on physical quantities out of the data on the industrial machine in the direction of a time axis, based on the acquired data, extracts a plurality of pieces of data for learning including the plurality of pieces of partial time-series data, and performs machine learning using the extracted learning data, thereby generating a learning model.

### RELATED APPLICATIONS

The present application claims priority to Japanese Patent Application Number 2019-020409 filed Feb. 7, 2019, the disclosure of which is hereby incorporated by reference herein in its entirety.

### BACKGROUND OF THE INVENTION

### Field of the Invention

The present invention relates to a state determination device and a state determination method, and more particularly, to a state determination device and a state determination method for supporting maintenance of industrial machines.

### Description of the Related Art

The maintenance of an industrial machine, such as an injection molding machine, is performed regularly or on the occurrence of an abnormality. In maintaining the industrial machine, maintenance personnel determines the abnormality of the operating state of this industrial machine by using physical quantities indicative of the machine operating state having been recorded during the operation of the machine, and performs maintenance work such as replacement of abnormal components. The industrial machine may be any of machines including an injection molding machine, machine tool, mining machinery, woodworking machinery, agricultural machinery, construction machinery, and the like.

For maintenance work for a check valve of an injection cylinder of the injection molding machine, as a kind of the industrial machine, for example, there is a known method in which a screw is regularly removed from the injection cylinder so that the dimensions of the check valve can be measured directly. In this method, however, production must be suspended for the measurement work, so that the productivity is inevitably reduced.

To solve this problem, there is a known method of abnormality diagnosis. In this method, an abnormality is diagnosed by indirectly detecting a wear amount of the check valve of the injection cylinder without suspending the production for the removal of the screw from the injection cylinder or the like. Also, in this diagnosis method, the abnormality is diagnosed by detecting a rotational torque on the screw or a phenomenon of flowing backward of a resin relative to the screw.

For example, Japanese Patent Application Laid-Open No. 01-168421 discloses a method in which a rotational torque influential on a screw is measured and an abnormality is identified if a tolerance range is exceeded by the measured value. Moreover, Japanese Patent Applications Laid-Open Nos. 2017-030221 and 2017-202632 disclose methods in which an abnormality is diagnosed by supervised learning of a drive part load, resin pressure, and the like. Furthermore, Japanese Patent Application Laid-Open No. 2018-097616 discloses a learning method in which machine learning of a plurality of pieces of time-series data is performed and clustering of feature vectors are carried out.

However, in an industrial machine such as an injection molding machine whose drive part includes constituent elements of different specifications, equipment that constitutes this machine and members handled in the machine are various. Therefore, there is a problem that the divergence between measured values obtained from the machine and the numerical values of learning data input during machine learning is so great that diagnosis by the machine learning cannot be performed correctly. If the type of the equipment of the movable part constituting the injection molding machine, the type of a resin as the raw material of molded articles manufactured by the injection molding machine, or the types of a mold, mold temperature controller, resin dryer, and the like, as incidental facilities of the injection molding machine, are different from learning conditions during learning model creation by the machine learning, for example, the measured values obtained from the machine diverge from measured values used during the learning model creation, so that state determination for the abnormality by the machine learning sometimes cannot be performed correctly.

To increase the diagnosis accuracy of the machine learning, there is a means for preparing a wide variety of learning conditions for the machine learning in creating the learning model of the machine learning. However, the machine learning based on the assortment of a wide variety injection molding machines, resins, and incidental facilities requires high cost. In addition, the operation of the machine also requires preparation of raw materials such as resins and workpieces, and the cost of the raw materials required for the acquisition of the learning data is also high. Moreover, the work for acquiring the learning data takes much time. Accordingly, there is a problem that the learning data cannot be collected efficiently.

### SUMMARY OF THE INVENTION

Thus, there is a demand for a state determination device and a state determination method capable of efficiently performing machine learning without requiring high cost, based on measured values acquired from an industrial machine, and supporting the maintenance of various industrial machines using the result of the learning.

Thereupon, a state determination device and method according to the present invention solve the above problems by creating a plurality of pieces of learning data by sliding (or shifting) time-series data (current, speed, etc.) acquired from an industrial machine in units of a predetermined number of data or time, in the direction of a time axis, and performing machine learning of a plurality of pieces of learning data generated from a single time-series data, thereby introducing a general-purpose learning model free from overtraining during the machine learning and implementing high-accuracy estimation of the operating state and abnormality degree.

A state determination device according to one aspect of the present invention is configured to determine an operating state of an industrial machine and includes a data acquisition unit configured to acquire data on the industrial machine, a learning data extraction unit configured to create a plurality of pieces of partial time-series data obtained by sliding time-series data on physical quantities out of the data on the industrial machine in the direction of a time axis, based on the data on the industrial machine acquired by the data acquisition unit, and extract a plurality of pieces of data for learning including the plurality of pieces of partial time-series data, and a learning unit configured to perform machine learning using the learning data extracted by the learning data extraction unit, thereby generating a learning model.

The state determination device may further comprise an estimation unit configured to perform estimation of the operating state of the industrial machine using the learning model generated by the learning unit.

The state determination device may further comprise an extraction condition storage unit configured to store conditions for the learning data extraction unit to extract the plurality of pieces of learning data, including the plurality of pieces of partial time-series data obtained by sliding the time-series data in the time axis direction, as the number of pieces of data within a range of a predetermined time duration or time-series data.

The industrial machine may be an injection molding machine, and the time-series data acquired by the data acquisition unit may include at least one of pieces of information for identifying a mold closing process, mold clamping process, injection process, packing process, metering process, mold opening process, ejection process, cycle start, and cycle end, as molding processes of the injection molding machine, and include at least one of pieces of information including the current, voltage, torque, position, speed, and acceleration of a motor for driving the injection molding machine, and a pressure, temperature, flow rate, and flow velocity related to a molding operation of the injection molding machine.

The learning unit may be supervised learning, unsupervised learning, and/or reinforcement learning.

The physical quantities of the time-series data acquired by the data acquisition unit may include at least one of physical quantities that a plurality of industrial machines connected by a wired/wireless network have.

The estimation unit may estimate an abnormality degree related to the operating state of the industrial machine, and the state determination device may display a warning message on a display device if a predetermined threshold is exceeded by the abnormality degree estimated by the estimation unit.

The estimation unit may estimate an abnormality degree related to the operating state of the industrial machine, and the state determination device may display a warning icon on a display device if a predetermined threshold is exceeded by the abnormality degree estimated by the estimation unit.

The estimation unit may estimate an abnormality degree related to the operating state of the industrial machine, and the state determination device may output at least one of commands for suspension of operation, deceleration, and restriction of the torque of a motor to the industrial machine.

A motor for driving the industrial machine may be an electric motor, oil-hydraulic cylinder, oil-hydraulic motor, or air motor, and a transmission mechanism for driving the industrial machine may include a ball screw, gear, pulley and/or belt.

A state determination method according to another aspect of the present invention serves to determine an operating state of an industrial machine and includes a data acquisition step for acquiring data on the industrial machine, a learning data extraction step for creating a plurality of pieces of partial time-series data obtained by sliding time-series data on physical quantities out of the data on the industrial machine in the direction of a time axis, based on the data on the industrial machine acquired in the data acquisition step, and extracting a plurality of pieces of data for learning including the plurality of pieces of partial time-series data, and a learning step for performing machine learning using the learning data extracted in the learning data extraction step, thereby generating a learning model.

The state determination method may further comprise an estimation step for performing estimation of the operating state of the industrial machine using the learning model generated in the learning step.

The present invention, having the structure described above, can mitigate work for collection of a wide variety of time-series data by efficiently using a single time-series data, thereby implementing efficient collection of learning data. Moreover, the determination accuracy of machine learning can be expected to be improved by generating a plurality of pieces of learning data for the machine learning from a single time-series data.

### BRIEF DESCRIPTION OF THE DRAWINGS

FIG. 1 is a schematic hardware configuration diagram of a state determination device according to one embodiment;

FIG. 2 is a schematic functional block diagram of the state determination device according to the one embodiment;

FIG. 3 is a diagram illustrating creation of data for learning by a learning data extraction unit;

FIG. 4 is a diagram showing an example of processing for creating slid time-series data by the learning data extraction unit;

FIG. 5 is a diagram showing another example of the processing for creating the slid time-series data by the learning data extraction unit; and

FIG. 6 is a diagram showing a display example of an abnormal state.

### DETAILED DESCRIPTION OF THE PREFERRED EMBODIMENTS

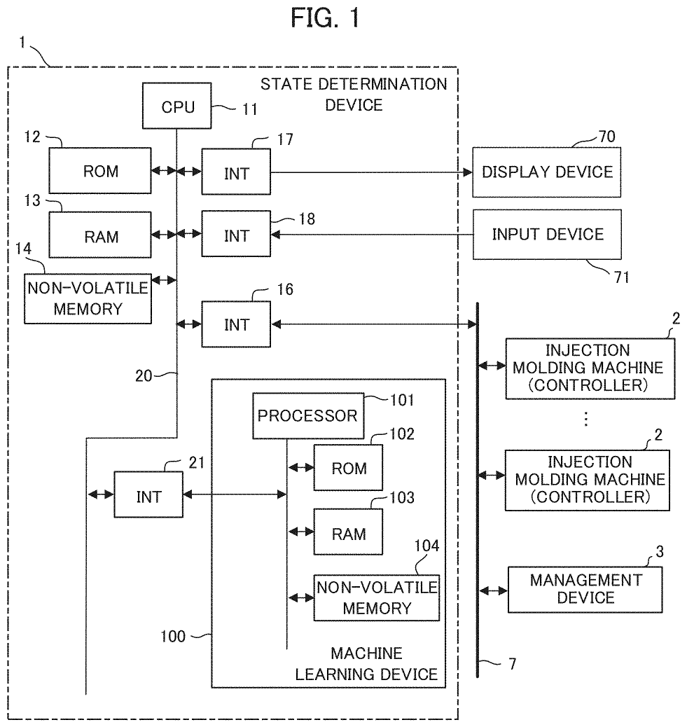

FIG. 1 is a schematic hardware configuration diagram showing principal parts of a state determination device comprising a machine learning device according to one embodiment.

A state determination device 1 of the present embodiment can, for example, be mounted on a controller for controlling industrial machines or implemented as a personal computer adjoined to the controller for controlling the industrial machines, a management device 3 connected to the controller through a wired/wireless network, or a computer such as an edge computer, fog computer, or cloud server. In the following description, the state determination device 1 of the present embodiment will be described as being implemented as the computer connected to the controller for controlling injection molding machines as the industrial machines through the network, by way of example.

While an injection molding machine will be described as an industrial machine in each of embodiments described below, the industrial machines as possible objects of state determination include an injection molding machine, machine tool, robot, mining machinery, woodworking machinery, agricultural machinery, construction machinery, and the like.

A CPU 11 of the state determination device 1 according to the present embodiment is a processor for generally controlling the state determination device 1. The CPU 11 reads out system programs stored in a ROM 12 via a bus 20 and controls the entire state determination device 1 according to these system programs. A RAM 13 is temporarily loaded with temporary calculation data, various data input by a worker through an input device 71, and the like.

A non-volatile memory 14 is composed of, for example, a memory backed up by a battery (not shown) or an SSD (solid state drive) and its storage state can be maintained even when the state determination device 1 is powered off. The non-volatile memory 14 stores a setting area loaded with setting information on the operation of the state determination device 1, data input from the input device 71, and static data (machine type, mass and material of a mold, resin type, etc.) acquired from injection molding machines 2 through a network 7, time-series data on physical quantities (the temperature of a nozzle, the position, speed, acceleration, current, voltage, and torque of a motor for driving the nozzle, the temperature of the mold, the flow rate, flow velocity, and pressure of the resin, etc.) detected during molding operations of the injection molding machines 2, data read from other computers through external storage devices (not shown) or the network 7, and the like. The programs and various data stored in the non-volatile memory 14 may be developed in the RAM 13 during execution and use. Moreover, the system programs, including a conventional analysis program for analyzing the various data, a program for controlling exchange with a machine learning device 100 (described later), and the like, are previously written in the ROM 12.

The state determination device 1 is connected to the wired/wireless network 7 through an interface 16. The network 7 is connected with at least one of the injection molding machines 2, the management device 3 for managing manufacturing work by the injection molding machine 2, and the like and exchanges data with the state determination device 1.

Each injection molding machine 2 is a machine configured to manufacture molded articles of a resin such as plastic. The injection molding machine 2 melts the resin as a material and fills (injects) it into the mold to perform molding. The injection molding machine 2 includes various pieces of equipment including the nozzle, the motor, a transmission mechanism, a speed reducer, and the moving part. The states of various parts are detected by sensors or the like and the operations of the various parts are controlled by the controller. For example, an electric motor, oil-hydraulic cylinder, oil-hydraulic motor, or air motor may be used as the motor for the injection molding machine 2. Moreover, a ball screw, gears, pulleys, a belt, and the like may be used for the transmission mechanism for the injection molding machine 2.

Data read onto the memories, data obtained as the result of execution of the programs and the like, data output from the machine learning device 100 (described later), and the like are output through an interface 17 and displayed on a display device 70. Moreover, the input device 71, which is composed of a keyboard, pointing device, and the like, delivers commands, data, and the like based on the worker's operation to the CPU 11 through an interface 18.

An interface 21 serves to connect the state determination device 1 and the machine learning device 100. The machine learning device 100 includes a processor 101, ROM 102, RAM 103, and non-volatile memory 104. The processor 101 serves to control the entire machine learning device 100. The ROM 102 stores the system programs and the like. The RAM 103 serves for temporary storage in each step of processing related to machine learning. The non-volatile memory 104 is used to store learning models and the like. The machine learning device 100 can observe various pieces of information (e.g., various data, such as the type of the injection molding machine 2, the mass and material of the mold, and the type of the resin, and time-series data on various physical quantities, such as the temperature of the nozzle, the position, speed, acceleration, current, voltage, and torque of the motor for driving the nozzle, the temperature of the mold, and the flow rate, flow velocity, and pressure of the resin) that can be acquired by the state determination device 1 through the interface 21. Moreover, the state determination device 1 acquires the result of processing output from the machine learning device 100 and stores, displays, and sends the acquired result to other devices through the network 7 or the like.

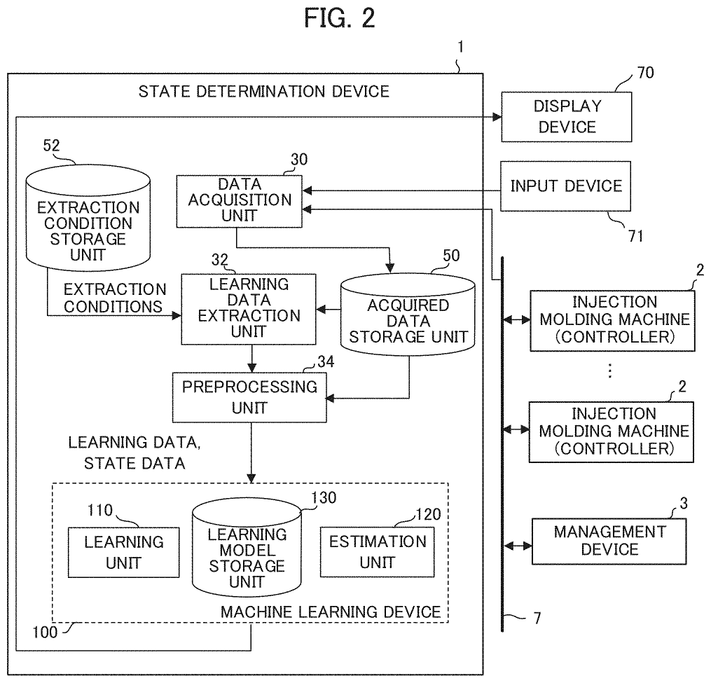

FIG. 2 is a schematic functional block diagram of the state determination device 1 and the machine learning device 100 according to the one embodiment.

The state determination device 1 of the present embodiment has a structure required when the machine learning device 100 performs learning. Each of functional blocks shown in FIG. 2 is implemented as the CPU 11 of the state determination device 1 and the processor 101 of the machine learning device 100 shown in FIG. 1 execute their respective system programs and control operations of the individual parts of the state determination device 1 and the machine learning device 100.

The state determination device 1 of the present embodiment includes a data acquisition unit 30, a learning data extraction unit 32, a preprocessing unit 34, and the machine learning device 100. The machine learning device 100 includes a learning unit 110 and an estimation unit 120. Moreover, an acquired data storage unit 50 and an extraction condition storage unit 52 are provided on the non-volatile memory 14 of the state determination device 1. The acquired data storage unit 50 stores data acquired from external machines or the like. The extraction condition storage unit 52 stores conditions for extracting learning data from the acquired data. A learning model storage unit 130 is provided on the non-volatile memory 104 of the machine learning device 100. The learning model storage unit 130 stores learning models constructed by machine learning by the learning unit 110.

The data acquisition unit 30 acquires various data input from the injection molding machine 2, input device 71, and the like. The data acquisition unit 30 acquires, for example, static data, such as the type of the injection molding machine 2, the mass and material of the mold, and the type of the resin, time-series data on various physical quantities, such as the temperature of the nozzle, the position, speed, acceleration, current, voltage, and torque of the motor for driving the nozzle, the temperature of the mold, and the flow rate, flow velocity, and pressure of the resin, and various data such as information (a kind of time-series data acquired in association with time) for identifying a mold closing process, mold clamping process, injection process, packing process, metering process, mold opening process, ejection process, cycle start, and cycle end, as molding processes of the injection molding machine 2, and information on maintenance work of the injection molding machine input by the worker, and stores these data into the acquired data storage unit 50. In acquiring the time-series data, the data acquisition unit 30 regards the time-series data acquired within a predetermined time range (e.g., range of one-cycle molding processes) as a single time-series data and then stores it into the acquired data storage unit 50, based on changes of signal data acquired from the injection molding machine 2 and other time-series data. The data acquisition unit 30 may be configured to acquire the data from the management device 3 or other computers through the external storage devices (not shown) or the wired/wireless network 7.

In the stage of the machine learning by the learning unit 110, the learning data extraction unit 32 extracts data to be used for learning from the acquired data acquired by the data acquisition unit 30 (and stored in the acquired data storage unit 50), based on extraction conditions stored in the extraction condition storage unit 52. A time width Wd (e.g., a time equivalent to the range of the one-cycle molding processes) of a single time-series data (partial time-series data) to be extracted and a slide amount Δt for sliding (or shifting) the time-series data are previously set in the extraction condition storage unit 52. The set value of the slide amount Δt may, for example, be designed to be a numerical value smaller than the time width Wd or a time coincident with the mold closing process, mold clamping process, injection process, packing process, metering process, mold opening process, and ejection process as the molding processes of the injection molding machine 2. The slide amount Δt may be set in units of time or the number of pieces of acquired data.

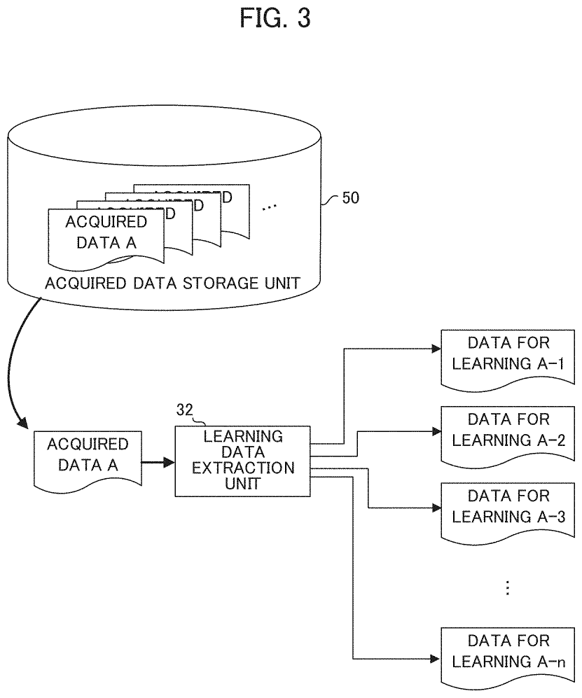

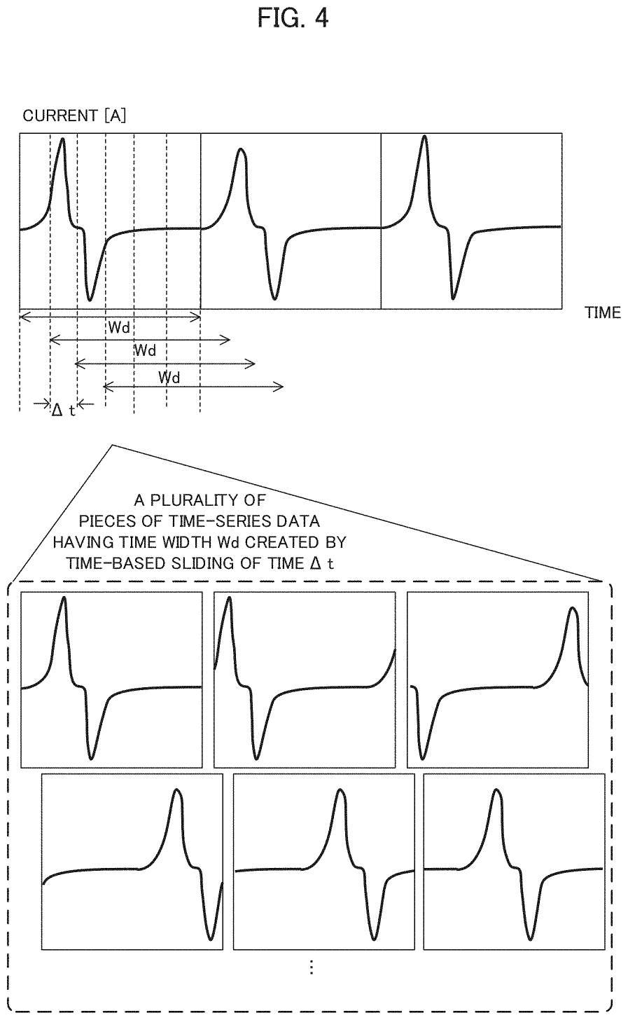

As shown in FIG. 3, the learning data extraction unit 32 creates a plurality of pieces of time-series data obtained by sliding the time-series data included in the individual acquired data stored in the acquired data storage unit 50, and extracts a plurality of pieces of acquired data individually including the plurality of pieces of created time-series data as data for learning. Here, creation of the time-series data obtained by sliding the time-series data on a time axis implies creation of partial time-series data obtained by shifting the start time by the predetermined slide amount Δt at a time with the time width Wd, for a series of objective time-series data, as shown in FIG. 4.

The acquired data include, for example, static data that do not change with the lapse of time and time-series data that record changes with the lapse of time. The learning data extraction unit 32 creates a plurality of pieces of partial time-series data slid on the time axis from the time-series data and extracts a plurality of pieces of acquired data obtained by combining those partial time-series data individually with the static data.

If the partial time-series data slid by the slide amount Δt at a time with the time width Wd are designed to be created under extraction conditions stored in the extraction condition storage unit 52 when the static data include a model name FN-1 and a resin type RE1 and acquired data (FN-1, RE1, ECi) including a current ECi are supposed to be an object of extraction of data for learning, the learning data extraction unit 32 creates partial time-series data ECi₁, ECi₂, . . . ECiₙ with the time width Wd obtained by sliding the time-series data ECi on the time axis by Δt at a time, and extracts, as data for learning, n pieces of (FN-1, RE1, ECi₁), (FN-1, RE1, ECi₂), . . . (FN-1, RE1, ECiₙ) obtained by individually combining these n pieces of partial time-series data and static data FN-1 and RE1.

As another example, if the partial time-series data slid by the slide amount Δt at a time with the time width Wd are designed to be created under the extraction conditions stored in the extraction condition storage unit 52 when the static data include the model name FN-1 and the resin type RE1 and acquired data (FN-1, RE1, ECi, PR) including the current ECi and a pressure PR are supposed to be the object of extraction of data for learning, the learning data extraction unit 32 (1) creates the partial time-series data ECi₁, ECi₂, . . . ECiₙ with the time width Wd obtained by sliding the time-series data ECi on the time axis by Δt at a time, (2) creates partial time-series data PR₁ to PRₙ with the time width Wd obtained by sliding the time-series data PR on the time axis by Δt at a time, and (3) extracts, as data for learning, n pieces of data (FN-1, RE1, ECi₁, PR₁), (FN-1, RE1, ECi₂, PR₂), . . . (FN-1, RE1, ECiₙ, PRₙ) obtained by individually combining the n pieces of partial time-series data and static data FN-1 and RE1.

If a plurality of pieces of time-series data are thus included in the acquired data, data for learning are created in such a manner that the partial time-series data created based on the individual time-series data are combined in a set with the time-series data slid by the same slide amount. This is because it is significant to learn the changes of the individual time-series data at the same time if the plurality of pieces of time-series data are included.

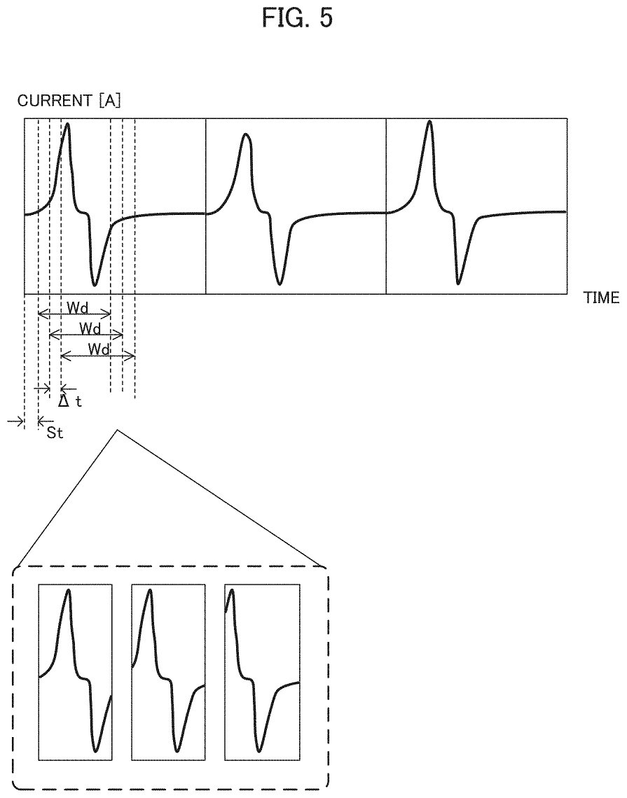

As shown in FIG. 5, the extraction condition storage unit 52 may further include an extraction start position St for the partial time-series data created from the time-series data included in the acquired data. For example, the extraction start position St may be set using a predetermined process in the operation of the injection molding machine 2 or a cycle start time, or may be set using the predetermined process or the cycle start time with a predetermined time width Δt_{d} added.

A plurality of pieces of partial time-series data including, for example, a waveform (e.g., injection process in which the waveform of a current value in FIG. 4 fluctuates vertically) in which a predetermined process appears among the time-series data stored in the acquired data storage unit 50, for example, can be extracted as data for learning by setting the extraction start position St for the partial time-series data together with the time width Wd and the slide amount Δt of the partial time-series data.

In the stage of the machine learning by the machine learning device 100, the preprocessing unit 34 creates learning data to be used for the learning by the machine learning device 100 based on the data for learning extracted by the learning data extraction unit 32. The preprocessing unit 34 creates learning data obtained by converting (or quantifying or sampling) data input from the learning data extraction unit 32 into a unified form to be handled in the machine learning device 100. In the case where the machine learning device 100 performs unsupervised learning, for example, the preprocessing unit 34 creates, as the learning data, state data S of a predetermined format in the learning. If the machine learning device 100 performs supervised learning, the preprocessing unit 34 creates, as the learning data, a set of state data S and label data L of a predetermined format in the learning. If the machine learning device 100 performs reinforcement learning, the preprocessing unit 34 creates, as the learning data, a set of state data S and determination data D of a predetermined format in the learning.

Moreover, in the stage of estimation by the machine learning device 100, the preprocessing unit 34 converts (or quantifies or samples) the acquired data acquired by the data acquisition unit 30 (and stored in the acquired data storage unit 50) into the unified form to be handled in the machine learning device 100, thereby creating the state data S of a predetermined format used for the estimation by the machine learning device 100.

The learning unit 110 of the machine learning device 100 performs the machine learning using the learning data created by the preprocessing unit 34 based on the data for learning extracted by the learning data extraction unit 32. The learning unit 110 generates a learning model by performing machine learning using the data acquired from the injection molding machine 2, based on a conventional machine learning method such as the unsupervised learning, supervised learning, or reinforcement learning, and stores the generated learning model in the learning model storage unit 130. The method of the unsupervised learning performed by the learning unit 110 may be represented by, for example, the autoencoder method or k-means method, while the supervised learning method may be represented by, for example, the multilayer perceptron method, recurrent neural network method, long short-term memory method, or convolutional neural network method. The reinforcement learning method may be represented by, for example, the Q-learning method.

The learning unit 110 can perform unsupervised learning based on, for example, learning data obtained as the acquired data acquired from the injection molding machine 2 in a normally operating state are processed by the learning data extraction unit 32 and the preprocessing unit 34 and generate, as a learning model, the distribution of data acquired in a normal state. Using learning models generated in this manner, the estimation unit 120 (described later) can estimate the extent of deviation of the state data S obtained as the acquired data acquired from the injection molding machine 2 are processed by the preprocessing unit 34 from the state data acquired during the normal-state operation and calculate an abnormality degree as the result of the estimation.

Moreover, the learning unit 110 can, for example, perform supervised learning using learning data as the acquired data are processed by the learning data extraction unit 32 and the preprocessing unit 34 in such a manner that a normal label is applied to the acquired data acquired from the normally operating injection molding machine and an abnormal label is applied to the acquired data acquired from the injection molding machine 2 before and after the occurrence of an abnormality, thereby generating discrimination boundaries between the normal and abnormal data as learning models. Using the learning models generated in this manner, the estimation unit 120 (described later) can input the state data S obtained as the acquired data acquired from the injection molding machine 2 are processed by the preprocessing unit 34 to the learning models, estimating whether the state data S belong to the normal data or to the abnormal data and calculating a label value (normal/abnormal) as the result of the estimation and its degree of reliability.

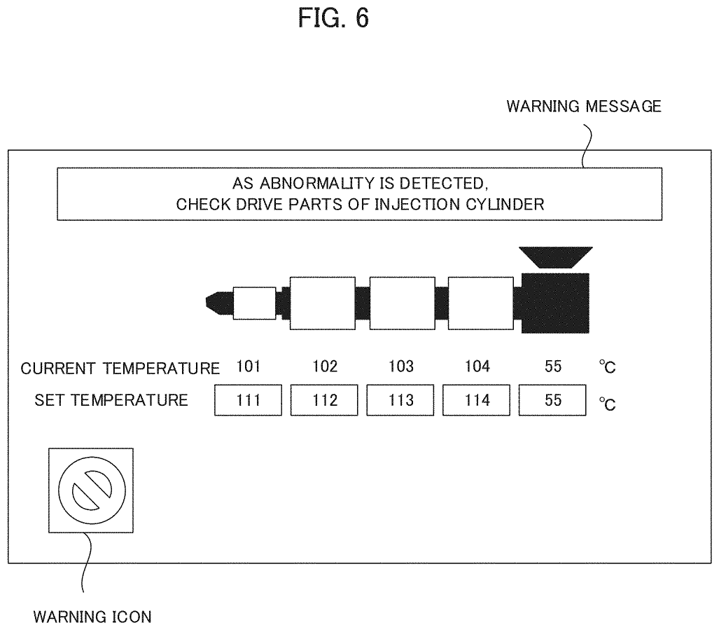

Based on the state data S created by the preprocessing unit 34, the estimation unit 120 of the machine learning device 100 estimates the state of the injection molding machine using the learning models stored in the learning model storage unit 130. In the estimation unit 120 of the present embodiment, the abnormality degree related to the state of the injection molding machine is estimated and calculated or the class (normal/abnormal, etc.) to which the operating state of the injection molding machine belongs is estimated and calculated by inputting state data S obtained from the preprocessing unit 34 to the learning model generated by the learning unit 110 (or for which parameters are settled). The result of the estimation by the estimation unit 120 (the abnormality degree related to the state of the injection molding machine, the class to which the operating state of the injection molding machine belongs, etc.) may be used by being output for display on the display device 70 or output for transmission to a host computer, cloud computer, or the like through a wired/wireless network (not shown). Moreover, if the result of the estimation by the estimation unit 120 proves to be a predetermined state (e.g., if a predetermined threshold is exceeded by the abnormality degree estimated by the estimation unit 120 or if the class to which the operating state of the injection molding machine estimated by the estimation unit 120 belongs is found to be “abnormal”), a warning message and icon may be output for display on the display device 70, as illustrated in FIG. 6, for example, or a command for suspension of operation, deceleration, or restriction of the motor torque may be output to the injection molding machine.

In the state determination device 1 having the above structure, a plurality of pieces of data for learning are created from a single acquired data as the learning data extraction unit 32 creates a plurality of pieces of partial time-series data obtained by sliding the time-series data included in the acquired data acquired from the injection molding machine according to the extraction conditions stored in the extraction condition storage unit 52. In this way, a lot of learning data can be created from a predetermined number of pieces of acquired data obtained from the restricted operation of the injection molding machine 2. Therefore, the learning unit 110 included in the machine learning device 100 can efficiently advance the learning to support the maintenance of various industrial machines without requiring high cost and generate learning models that can flexibly overcome waveform deviations in the time axis direction.

While the state determination device 1 according to the present embodiment is applicable to the case in which states related to industrial machines such as robots and machine tools are determined, it can be suitably applied to industrial machines that unstably behave at the start of operation or if operating conditions are changed, for example. The operation of an injection molding machine, in particular, may sometimes be delayed depending on the internal and external states of the machine even when the operation is performed under the same injection conditions. Even in such a case, molding operations of the injection molding machine itself are normal, therefore data for learning such normal operations becomes necessary so as not to determine such data as abnormal. The state determination device 1 according to the present embodiment is useful for the state determination for the injection molding machine, in particular, since it can generate a plurality of pieces of data for learning by sliding the time-series data from the acquired data that can be conventionally acquired, without specially acquiring data and the like for the case in which the machine operation is thus delayed.

While embodiments of the present invention have been described above, the invention is not limited to the above-described embodiments and may be suitably modified and embodied in various forms.

For example, although the state determination device 1 and the machine learning device 100 are described as being devices that comprise different CPUs (processors) in the above embodiments, the machine learning device 100 may alternatively be implemented by the CPU 11 of the state determination device 1 and the system programs stored in the ROM 12 of the state determination device 1. Moreover, if a plurality of injection molding machines 2 are connected to one another through the network, their respective operating states may be determined by a single state determination device 1 or the state determination device 1 may be mounted on the controller of the injection molding machine.

1. A state determination device for determining an operating state of an industrial machine, the state determination device comprising:
a data acquisition unit configured to acquire data on the industrial machine;
a learning data extraction unit configured to create a plurality of pieces of partial time-series data obtained by sliding time-series data on physical quantities out of the data on the industrial machine in the direction of a time axis, based on the data on the industrial machine acquired by the data acquisition unit, and extract a plurality of pieces of data for learning including the plurality of pieces of partial time-series data; and
a learning unit configured to perform machine learning using the learning data extracted by the learning data extraction unit, thereby generating a learning model.

2. The state determination device according to claim 1, further comprising an estimation unit configured to perform estimation of the operating state of the industrial machine using the learning model generated by the learning unit.

3. The state determination device according to claim 1, further comprising an extraction condition storage unit configured to store conditions for the learning data extraction unit to extract the plurality of pieces of learning data, including the plurality of pieces of partial time-series data obtained by sliding the time-series data in the time axis direction, as the number of pieces of data within a range of a predetermined time duration or time-series data.

4. The state determination device according to claim 1, wherein the industrial machine is an injection molding machine, and the time-series data acquired by the data acquisition unit include at least one of pieces of information for identifying a mold closing process, mold clamping process, injection process, packing process, metering process, mold opening process, ejection process, cycle start, and cycle end, as molding processes of the injection molding machine, and includes at least one of pieces of information including the current, voltage, torque, position, speed, and acceleration of a motor for driving the injection molding machine, and a pressure, temperature, flow rate, and flow velocity related to a molding operation of the injection molding machine.

5. The state determination device according to claim 1, wherein the learning unit is supervised learning, unsupervised learning, and/or reinforcement learning.

6. The state determination device according to claim 1, wherein the physical quantities of the time-series data acquired by the data acquisition unit include at least one of physical quantities that a plurality of industrial machines connected by a wired/wireless network have.

7. The state determination device according to claim 2, wherein the estimation unit estimates an abnormality degree related to the operating state of the industrial machine, and the state determination device displays a warning message on a display device if a predetermined threshold is exceeded by the abnormality degree estimated by the estimation unit.

8. The state determination device according to claim 2, wherein the estimation unit estimates an abnormality degree related to the operating state of the industrial machine, and the state determination device displays a warning icon on a display device if a predetermined threshold is exceeded by the abnormality degree estimated by the estimation unit.

9. The state determination device according to claim 2, wherein the estimation unit estimates an abnormality degree related to the operating state of the industrial machine, and the state determination device outputs at least one of commands for suspension of operation, deceleration, and restriction of the torque of a motor to the industrial machine.

10. The state determination device according to claim 1, wherein a motor for driving the industrial machine is an electric motor, oil-hydraulic cylinder, oil-hydraulic motor, or air motor, and a transmission mechanism for driving the industrial machine includes a ball screw, gear, pulley and/or belt.

11. A state determination method for determining an operating state of an industrial machine, the state determination method comprising:
a data acquisition step for acquiring data on the industrial machine;
a learning data extraction step for creating a plurality of pieces of partial time-series data obtained by sliding time-series data on physical quantities out of the data on the industrial machine in the direction of a time axis, based on the data on the industrial machine acquired in the data acquisition step, and extracting a plurality of pieces of data for learning including the plurality of pieces of partial time-series data; and
a learning step for performing machine learning using the learning data extracted in the learning data extraction step, thereby generating a learning model.

12. The state determination method according to claim 11, further comprising an estimation step for performing estimation of the operating state of the industrial machine using the learning model generated in the learning step.
